(19) United States
(12) Patent Application Publication
(10) Pub. No.: US 2019/0122546 A1
(43) Pub. Date: Apr. 25, 2019

(54) SYSTEMS AND METHODS FOR ANALYZING AND ADJUSTING ROAD CONDITIONS

(71) Applicant: BEIJING DIDI INFINITY TECHNOLOGY AND DEVELOPMENT CO., LTD., Beijing (CN)

(72) Inventors: Dong LU, Beijing (CN); Jiali LI, Beijing (CN)

(73) Assignee: BEIJING DIDI INFINITY TECHNOLOGY AND DEVELOPMENT CO., LTD., Beijing (CN)

(21) Appl. No.: 16/220,119

(22) Filed: Dec. 14, 2018

Related U.S. Application Data
(63) Continuation of application No. PCT/CN2018/090379, filed on Jun. 8, 2018.

(30) Foreign Application Priority Data
Jun. 12, 2017 (CN) 201710439453.8
Jun. 12, 2017 (CN) 201710440208.9
Jun. 12, 2017 (CN) 201710440210.6

(51) Int. Cl. G08G 1/01; G08G 1/056

(52) U.S. Cl. CPC G08G 1/0145; G08G 1/056; G08G 1/0133; G08G 1/0112

(57) ABSTRACT

Embodiments of the disclosure provide methods and systems for adjusting road conditions. The system includes a communication interface configured to receive driving information indicative of vehicle driving records on a road. The road includes first and second direction lanes. The system includes a storage configured to store preset parameters. The system includes a processor configured to divide the road into road segments and determine a first traffic congestion index and a second traffic congestion index for the first direction lane and the second direction lane, respectively, based on the driving information associated with each road segment and the preset parameters. The processor is configured to determine a directional imbalance index for the road based on the first and second traffic congestion indices. The processor is configured to provide an instruction to adjust the first direction lane and/or the second direction lane of the road based on the directional imbalance index.

### CROSS REFERENCE TO RELATED APPLICATIONS

The present application is a continuation of International Application No. PCT/CN2018/090379, filed on Jun. 8, 2018, which further is based on and claims the benefits of priority to Chinese Application No. 201710440208.9, filed Jun. 12, 2017, Chinese Application No. 201710439453.8, filed Jun. 12, 2017, and Chinese Application No. 201710440210.6, filed Jun. 12, 2017. The entire contents of all applications are incorporated herein by reference.

### TECHNICAL FIELD

The present disclosure relates to systems and methods for analyzing and adjusting road conditions, and more particularly to, systems and methods for analyzing and adjusting traffic conditions of a two-way road based on driving information associated with the road.

### BACKGROUND

The nature of urban roads causes uneven distribution of traffic hotspots in both time and space. In certain time periods, some two-way roads suffer from serious traffic congestion in both directions. Driving into these roads without knowing the traffic congestion will not only worsen the traffic congestion, but also increase the drivers' commute time. Also, in some time periods, such as the morning and afternoon rush hours, the traffic congestion may occur in only one direction of a two-way road, leaving lanes in the other direction with a very low utilization rate. This directional imbalance of traffic load on a two-way road is known as “tidal lane.”

To reduce traffic congestion and improve traffic load balance of two-way roads, traffic control and management personnel may identify tidal lanes by direct observation, image capturing at certain road segments, or traffic volume estimation based on the speedometer of a survey vehicle. However, those indirect means suffer from various problems, such as requesting tremendous staffing for observation and maintenance of image capturing equipment, redundant data accumulation due to continuous monitoring, and inaccuracy in traffic volume estimation caused by the survey vehicle condition and driver.

Embodiments of the disclosure address the above problems by improved systems and methods for road condition analysis and adjustment.

### SUMMARY

Embodiments of the disclosure provide a system for adjusting road conditions. The system may include a communication interface configured to receive driving information indicative of vehicle driving records on a road. The road includes a first direction lane and a second direction lane. The system may further include a storage configured to store a set of preset parameters. The system may also include a processor configured to divide the road into one or more road segments. The processor may be also configured to determine a first traffic congestion index and a second traffic congestion index for the first direction lane and the second direction lane, respectively, based on the driving information associated with each of the road segments and the set of preset parameters. The processor may be further configured to determine a directional imbalance index for the road based on the first traffic congestion index and the second traffic congestion index. The processor may be further configured to provide an instruction to adjust at least one of the first direction lane and the second direction lane of the road based on the directional imbalance index.

Embodiments of the disclosure also provide a method for adjusting road conditions. The method may include receiving driving information indicative of vehicle driving records on a road. The road includes a first direction lane and a second direction lane. The method may also include dividing, by a processor, the road into one or more road segments. The method may further include determining, by the processor, a first traffic congestion index and a second traffic congestion index for the first direction lane and the second direction lane, respectively, based on the driving information associated with each of the road segments and a set of preset parameters. The method may further include determining, by the processor, a directional imbalance index for the road based on the first traffic congestion index and the second traffic congestion index. The method may further include providing, by the processor, an instruction to adjust at least one of the first direction lane and the second direction lane of the road based on the directional imbalance index.

Embodiments of the disclosure further provide a non-transitory computer-readable medium having instructions stored thereon that, when executed by one or more processors, causes the one or more processors to perform operations. The operations may include receiving driving information indicative of vehicle driving records on a road. The road includes a first direction lane and a second direction lane. The operations may also include dividing, by a processor, the road into one or more road segments. The operations may further include determining, by the processor, a first traffic congestion index and a second traffic congestion index for the first direction lane and the second direction lane, respectively, based on the driving information associated with each of the road segments and a set of preset parameters. The operations may further include determining, by the processor, a directional imbalance index for the road based on the first traffic congestion index and the second traffic congestion index. The operations may further include providing, by the processor, an instruction to adjust at least one of the first direction lane and the second direction lane of the road based on the directional imbalance index.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary system for adjusting road conditions, according to embodiments of the disclosure.

FIG. 2 illustrates a block diagram of an exemplary server for analyzing and adjusting road conditions, according to embodiments of the disclosure.

FIG. 3 illustrates an exemplary target road and adjacent downstream roads, according to embodiments of the disclosure.

FIG. 4 illustrates an exemplary target road, according to embodiments of the disclosure.

FIG. 5 illustrates a flowchart of an exemplary method for adjusting road conditions, according to embodiments of the disclosure.

FIG. 6 illustrates a flowchart of an exemplary method for determining a traffic congestion index, according to embodiments of the disclosure.

FIG. 7 illustrates a flowchart of another exemplary method for determining a traffic congestion index, according to embodiments of the disclosure.

FIG. 8 illustrates a flowchart of an exemplary method for adjusting road conditions based on downstream road conditions, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

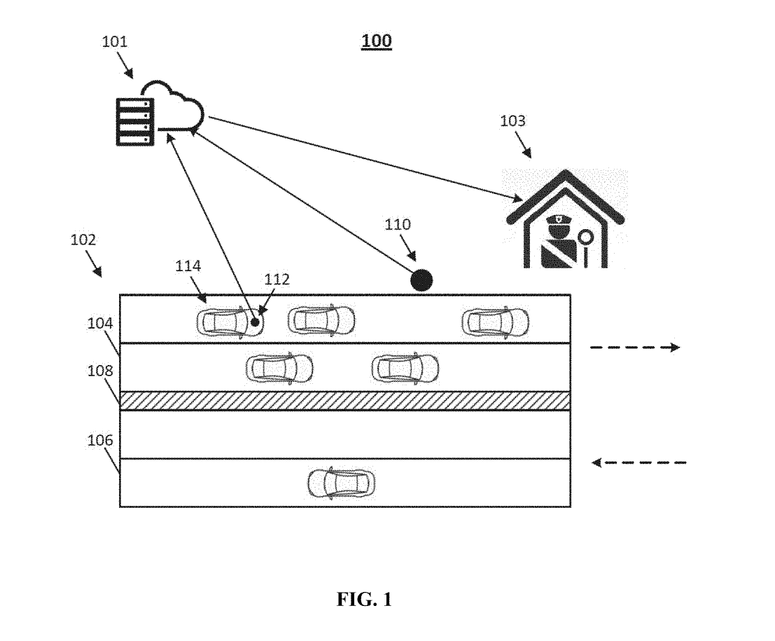

FIG. 1 illustrates a schematic diagram of an exemplary system 100 for adjusting road conditions, according to embodiments of the disclosure. System 100 may include a road condition analysis and adjustment server 101 (also referred to as server 101 for simplicity). Server 101 can be a general-purpose server or a proprietary device specially designed for analyzing and adjusting road conditions. It is contemplated that server 101 can be a stand-alone server or an integrated component of a stand-alone server. Because analyzing and adjusting road conditions may require significant computation resources, in some embodiments, server 101 may be implemented as a stand-alone system.

As illustrated in FIG. 1, server 101 may analyze the traffic conditions of a road 102 and adjust the traffic conditions of road 102 via a traffic control and management mechanism 103. Road 102 may be a two-way road that includes one or more first direction lanes 104 and one or more second direction lanes 106. The first and second directions may be opposite to each other and separated by a divider 108. It is contemplated that various factors can affect the degrees of traffic congestion of lanes in each direction of road 102, such as but not limited to, the location, the time of day, the day of week, the number of lanes, the traffic conditions of upstream and downstream roads, accidents, and the traffic light durations. In some embodiments, the degrees of traffic congestion of first direction lanes 104 and second direction lanes 106 may be different from one another, thereby making road 102 a “tidal lane.” The imbalance of traffic congestion between first and second direction lanes 104 and 106 may be undesirable and need to be adjusted. In some embodiments, server 101 may analyze the degrees of traffic congestion of first direction lanes 104 and second direction lanes 106, respectively, as well as the degree of traffic imbalance therebetween.

Consistent with the disclosures of the present application, server 101 may measure the degree of traffic congestion using the traffic congestion index (TCI) for each of first direction lanes 104 and second direction lanes 106, and measure the degree of traffic imbalance using a directional imbalance index (DII). Server 101 may determine the TCIs for each of first direction lanes 104 and second direction lanes 106 based on driving information associated with road 102. The driving information may be indicative of vehicle driving records on road 102 and include traffic volume, real-time driving speed, average driving speed, driving time, driving distance, etc. The driving information may be continuously, regularly, or intermittently captured by sensors 110 equipped along road 102 and/or sensors 112 equipped on vehicles 114 driving through road 102. Sensors 110 and 112 may include cameras, speedometers, or any other suitable sensors for obtaining driving information. In some embodiments, server 101 may continuously, or regularly, or intermittently retrieve the captured driving information from sensors 110 and 112. In some embodiments, vehicles 114 may report their driving records to server 101 as part of driving information.

Server 101 may calculate the TCIs based on the driving information in a certain time period (e.g., a week, a month, a quarter, or a year) and a set of preset parameters (e.g., non-traffic passage times and weights). Server 101 may further calculate the DII for road 102 based on the TCIs for first direction lanes 104 and second direction lanes 106. In some embodiments, server 101 may calculate the DII only when at least one of the TCIs is greater than a threshold, i.e., at least one of first direction lanes 104 and second direction lanes 106 has a significant traffic congestion in the time period as indicated by the TCIs larger than the threshold.

In response to a significant traffic imbalance (e.g., by comparing with a threshold), server 101 may instruct traffic control and management mechanism 103 to adjust first direction lanes 104 and/or second direction lanes 106 to reduce the traffic imbalance. Traffic control and management mechanism 103 may include a traffic control center, a local police station, a police officer, or any suitable automatic, semi-automatic, or manual means for controlling and managing traffic conditions of road 102. In some embodiments, to adjust traffic conditions of road 102, traffic control and management mechanism 103 may reallocate lanes in the first and second directions, for example, by using zipper trucks or changing divider 108. In some embodiments, traffic control and management mechanism 103 may change the durations of traffic lights adjacent to road 102, for example, by reducing the red-light duration and/or increasing the green-light duration in the heavy-traffic congestion direction, and/or increasing the red-light duration and/or reducing the green-light duration in the light-traffic congestion direction.

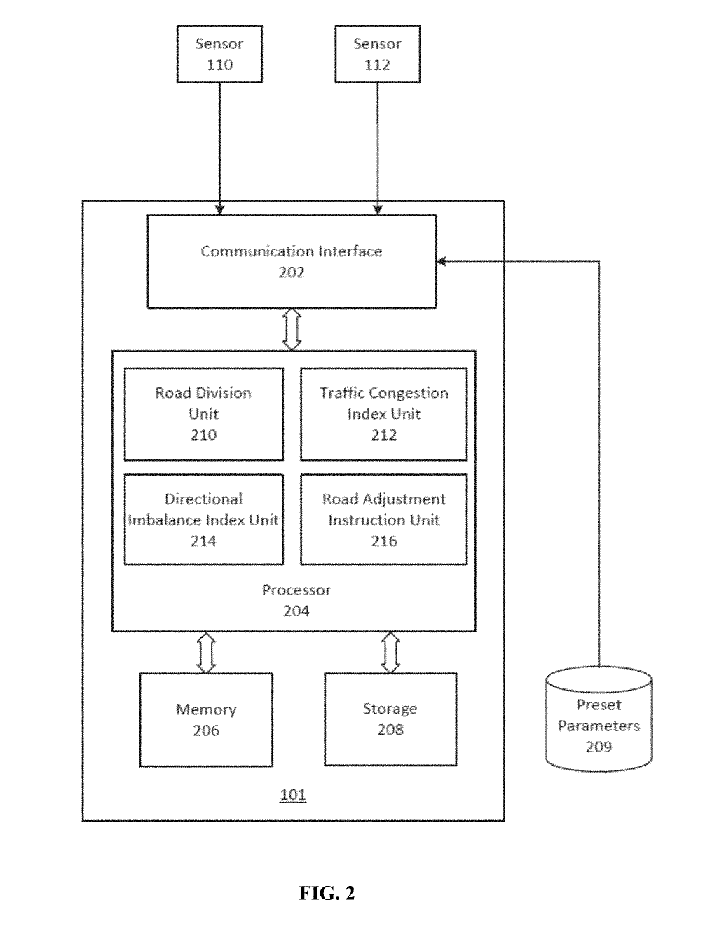

FIG. 2 illustrates a block diagram of exemplary server 101 for analyzing and adjusting road conditions, according to embodiments of the disclosure. Server 101 may include a communication interface 202, a processor 204, a memory 206, and a storage 208. In some embodiments, server 101 may have different modules in a single device, such as an integrated circuit (IC) chip (implemented as an application-specific integrated circuit (ASIC) or a field-programmable gate array (FPGA), or separate devices with dedicated functions. Components of server 101 may be in an integrated device, or distributed at different locations but communicate with each other through a network (not shown).

Communication interface 202 may send data to and receive data from components such as sensors 110 and 112 via communication cables, a Wireless Local Area Network (WLAN), a Wide Area Network (WAN), wireless networks such as radio waves, a nationwide cellular network, and/or a local wireless network (e.g., Bluetooth™ or WiFi), or other communication methods. In some embodiments, communication interface 202 can be an integrated services digital network (ISDN) card, cable modem, satellite modem, or a modem to provide a data communication connection. As another example, communication interface 202 can be a local area network (LAN) card to provide a data communication connection to a compatible LAN. Wireless links can also be implemented by communication interface 202. In such an implementation, communication interface 202 can send and receive electrical, electromagnetic or optical signals that carry digital data streams representing various types of information via a network.

Consistent with some embodiments, communication interface 202 may receive driving information acquired by sensors 110 and 112, and provide the received driving information to storage 208 for storage or to processor 204 for processing. Communication interface 202 may also receive an instruction to adjust the traffic conditions of road 102 generated by processor 204, and provide the instruction to traffic control and management mechanism 103 via a network. The driving information may be indicative of vehicle driving records on road 102, which includes first direction lanes 104 and second direction lanes 106.

Processor 204 may include any appropriate type of general-purpose or special-purpose microprocessor, digital signal processor, or microcontroller. Processor 204 may be configured as a separate processor module dedicated to analyzing and adjusting road conditions. Alternatively, processor 204 may be configured as a shared processor module for performing other functions unrelated to road condition adjustment.

As shown in FIG. 2, processor 204 may include multiple modules, such as a road division unit 210, a traffic congestion index unit 212, a directional imbalance index unit 214, a road adjustment instruction unit 216, and the like. These modules (and any corresponding sub-modules or sub-units) can be hardware units (e.g., portions of an integrated circuit) of processor 204 designed for use with other components or to execute a part of a program. The program may be stored on a computer-readable medium, and when executed by processor 204, it may perform one or more functions. Although FIG. 2 shows units 210-216 all within one processor 204, it is contemplated that these units may be distributed among multiple processors located near or remotely with each other.

Road division unit 210 may be configured to divide road 102 into one or more road segments for ease of analysis. Each road segment may be associated with a start coordinate, an end coordinate, and a distance. In some embodiments, each road segment may have the same distance, for example, determined based on the speed limit of road 102. In some embodiments, at least some road segments may be divided based on the entrances and/or exits (e.g., highway ramps and traffic lights) of road 102. As road 102 includes multiple lanes in opposite directions, i.e., first direction lanes 104 and second direction lanes 106, a road segment may be in the first or second direction. That is, first direction lanes 104 may be divided into a set of road segments in the first direction, and second direction lanes 106 may be divided into another set of road segments in the second direction. The driving information received by communication interface 202 may be associated with each road segment in first direction lanes 104 and second direction lanes 106. For example, vehicle driving records, such as vehicle volume, real-time vehicle speed, average vehicle speed, driving time, and driving distance, may be associated with each road segment of road 102.

Traffic congestion index unit 212 may be configured to determine a first TCI for first direction lanes 104 and a second TCI for second direction lanes 106 based on the driving information associated with each road segments and a set of preset parameters 209. Preset parameters 209 may be stored in a local or remote database operatively coupled to communication interface 202 of server 101 and retrieved by traffic congestion index unit 212 for calculating the TCIs. Preset parameters 209 may include non-traffic passage time for each road segment in first direction lanes 104 and second direction lanes 106, respectively. The non-traffic passage time indicates the theoretical driving time of a vehicle passing through the respective road segment without any traffic delay. For example, the non-traffic passage time may be calculated by dividing the distance of the road segment by the speed limit of the road segment or the historical average driving speed on the road segment.

In some embodiments, preset parameters 209 may also include weights for each road segment in first direction lanes 104 and second direction lanes 106, respectively. A weight may be preset based on various factors, such as but not limited to, historical vehicle volume, population density, and traffic accident rate, associated with the respective road segment.

To determine the TCI, traffic congestion index unit 212 may be configured to calculate actual passage time for each road segment in first direction lanes 104 and second direction lanes 106, respectively, based on the driving information. The actual passage time indicates the actual driving time of a vehicle passing through the respective road segment. In some embodiments, traffic congestion index unit 212 may analyze all the received vehicle driving records in the time period, filter out abnormal vehicle driving records, and average the filtered vehicle driving records to determine the actual passage time for each road segment in the time period. In some embodiments, to improve the accuracy of the actual passage time, driving records of only certain vehicles (e.g., with good driving history and low accident rate) may be used for calculating the actual passage time.

Traffic congestion index unit 212 may be configured to determine the first TCI based on the actual passage time and the non-traffic passage time for each road segment in first direction lanes 104, and determine the second TCI based on the actual passage time and the non-traffic passage time for each road segment in second direction lanes 106. For example, a TCI may be determined based on the ratio of the total actual passage time of all the road segments and the total non-traffic passage time of all the road segments. In some embodiments, the calculation of a TCI may take into account of the weights for each road segment as well. In one example, Equation (1) below illustrates an exemplary calculation of TCI:

$$TCI = \frac{{\sum }_{1}^{n} ( {t}_{n} \times {W}_{n} )}{{\sum }_{1}^{n} ( {T}_{n} \times {W}_{n} )} , \qquad ( 1 )$$

where n represents a positive integer, tₙ represents the actual passage time of the nth road segment in one direction of road 102, Tₙ represents the non-traffic passage time of the nth road segment, and Wₙ represents the weight of the nth road segment.

It is contemplated that environmental conditions, such as air quality, precipitation, visibility, humidity, and wind speed, may affect the road conditions and the calculation of the TCIs. Environmental information indicative of environmental conditions of road 102 may be received by serve 101, for example, from historical environmental data stored locally or remotely. In some embodiments, road division unit 210 may divide road 102 into road segments based additionally on the environmental information. For example, the distance of each road segment may be adjusted based on the environmental conditions. In one example, the distance may be increased when the vehicle driving speed is reduced due to historical bad air quality, large precipitation, low visibility, high humidity, and/or high wind speed. In some embodiments, traffic congestion index unit 212 may adjust the non-traffic passage time of each road segment based on the environmental conditions as well. For example, the non-traffic passage time of a respective road segment may be increased when the vehicle driving speed is reduced due to historical bad air quality, large precipitation, low visibility, high humidity, and/or high wind speed associated with the road segment. As a result, calculating the TCIs for first direction lanes 104 and second direction lanes 106 by traffic congestion index unit 212 may be performed based on the driving information, the environmental information, and the preset parameters (e.g., weights) associated with each road segment according to some embodiments.

Based on the TCI calculated by traffic congestion index unit 212, whether the corresponding lanes of road 102 have a significant traffic congestion in the time period may be determined by comparing with a threshold, for example, as part of preset parameters 209. In one example, the threshold may be set as 2, and any TCI larger than 2 may indicate the corresponding lanes have a significant traffic congestion in the time period. In another example, the threshold may be set as 1 or more, such as 1.1, 1.2, 1.3, 1.4, or 1.5. Consistent with the disclosures of the present application, in addition to understanding the traffic congestion in one direction, server 101 may further determine whether the traffic in both directions on road 102 is unbalanced (i.e., forming a “tidal lane”) in order to make the appropriate road adjustment instruction.

Directional imbalance index unit 214 may be configured to determine a DII for road 102 based on the first TCI and the second TCI. In one example, Equation (2) below illustrates how to calculate a DII:

$$DII = \frac{\vert {TCI}_{a} - {TCI}_{b} \vert}{min ( {TCI}_{a} , {TCI}_{b} )} , \qquad ( 2 )$$

where TCIₐ represents the first TCI, TCI_{b} represents the second TCI, min(TCIₐ, TCI_{b}) represents the minimum of the first and second TCIs, and |TCIₐ−TCI_{b}| represents the absolute value of the difference between the first and second TCIs. In some embodiments, directional imbalance index unit 214 may compare the calculated DII with a threshold (e.g., part of preset parameters 209) to determine whether the traffic in both directions of road 102 is unbalanced. In one example, the threshold may be 70%, and any DII larger than 70% may indicate unbalanced traffic in both directions of road 102. In some embodiments, directional imbalance index unit 214 may calculate the DII only when one of first and second direction lanes 104 and 106 have a significant traffic congestion (e.g., larger than the threshold). When none of first and second direction lanes 104 and 106 has a significant traffic congestion or both first and second direction lanes 104 and 106 have a significant traffic congestion, directional imbalance index unit 214 may not proceed to calculate the DII as the adjustment of road 102 becomes unnecessary or impractical.

Road adjustment instruction unit 216 may be configured to provide an instruction to adjust first direction lanes 104 and/or second direction lanes 106 based on the DII. In some embodiments, road adjustment instruction unit 216 may provide the instruction based on the one or both of the first and second TCIs as well. In one example, when one of first and second direction lanes 104 and 106 has a significant traffic congestion and the traffic in both directions of road 102 is unbalanced, road adjustment instruction unit 216 may provide an instruction to traffic control and management means to adjust the road conditions accordingly. In some embodiments, the number of lanes in the direction with a significant traffic congestion may be increased, while the number of lanes in the reversed direction may be deceased accordingly. For example, the direction of one or more lanes in the middle of road 102 (e.g., near divider 108) may be reversible and changed based on the instruction from server 101 to balance the traffic in both directions of road 102.

In some embodiments, road adjustment instruction unit 216 may consider the change of the TCI or DII in a certain time period to determine whether the TCI or DII in that time period should be used as a basis for the instruction. As the road condition analysis is usually performed in a relatively long time period, such as one week, one month, one quarter, or one year, in order to reveal the meaningful traffic pattern, any sudden change of the TCI or DII may not be useful in road condition analysis and adjustment. Thus, any change of the TCI or DII in a time interval that is larger than a threshold (e.g., part of preset parameters 209) may be filtered out by road adjustment instruction unit 216 as a noise signal.

Consistent with some embodiments of the present disclosure, the road conditions of the downstream road(s) of road 102 (e.g., as indicated by the TCIs and/or DII of the downstream road(s)) may affect the adjustment of the road conditions of road 102. For example, if the downstream road does not have a significant traffic congestion (e.g., having a TCI in the downstream direction smaller than the threshold), then the adjustment of road 102 may help reduce the traffic congestion. If the downstream road also has a significant traffic congestion, then the DII of the downstream road may need to be analyzed to see if the downstream can be adjusted together with road 102 to balance the traffic in both directions.

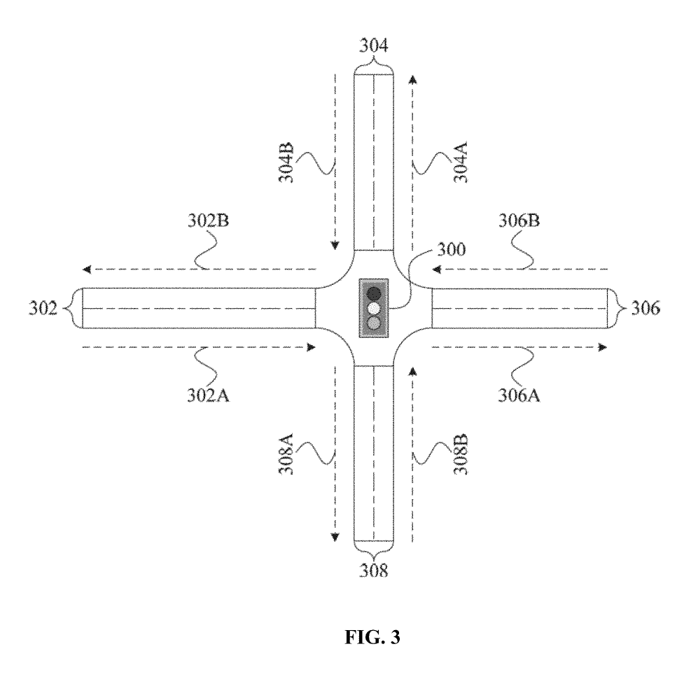

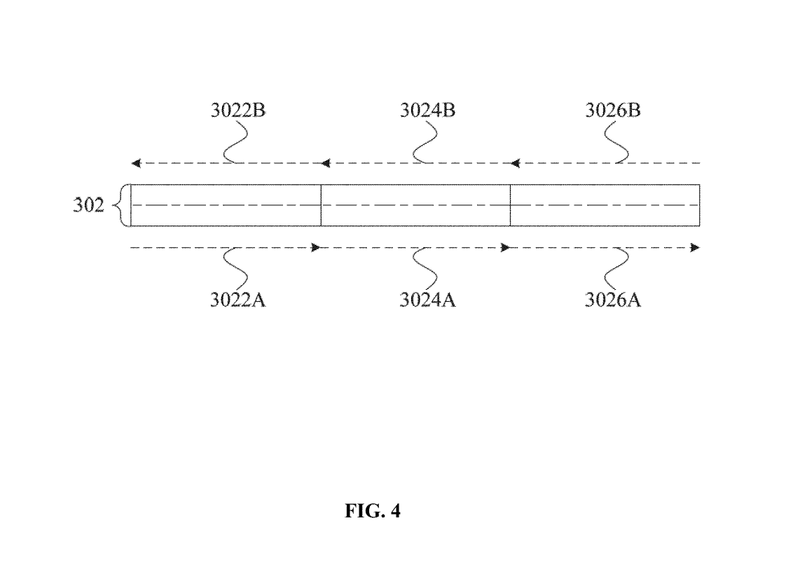

In some embodiments, road adjustment instruction unit 216 may be configured to identify a downstream road of road 102 base on first and second TCIs. Referring now to FIG. 3, a target road 302 (one example of road 102) includes a first direction lane 302A and a second direction lane 302B. As shown in FIG. 4, first direction lane 302A may be divided by road division unit 210 into a set of road segments 3022A, 3024A, and 3026A. Similarly, second direction lane 302B may be divided by road division unit 210 into another set of road segments 3022B, 3024B, and 3026B. The first TCI of first direction lane 302A and second TCI of second direction lane 302B may be determined by traffic congestion index unit 212 based on the driving information associated with each road segment as described above in detail. The downstream direction of road 302 may be determined based on the direction of lane with a significant traffic congestion, for example, by comparing the first and second TCIs with the threshold.

Assuming in FIG. 3, the first TCI is larger than the threshold while the second TCI is smaller than the threshold, the downstream direction is thus the first direction following first direction lane 302A. At the end of target road 302 in the downstream direction (indicated by a traffic light 300), there are three adjacent roads 304, 306, and 308, each having a first direction lane 304A, 306A, or 308A and a second direction lane 304B, 306B, or 308B. In some embodiments, not all downstream roads 304-308 adjacent to target road 302 need to be analyzed by road adjustment instruction unit 216. Road adjustment instruction unit 216 may identify one or more downstream roads based on the traffic diversion ratios of roads 304-308. In one example, road adjustment instruction unit 216 may identify a single downstream road with a traffic diversion ratio larger than 50%. That is, more than one half of the traffic volume exiting target road 302 goes to that downstream road. In another example, road adjustment instruction unit 216 may identify any downstream road(s) with a traffic diversion ratio larger than 40%. In still another example, road adjustment instruction unit 216 may identify one or more downstream roads with the highest traffic diversion ratio(s) regardless of the actual ratios. In FIG. 3, assuming the traffic diversion ratios of roads 304, 306, and 308 are 60%, 20%, and 20%, road adjustment instruction unit 216 may identify only road 304 for further analysis as its traffic diversion ratio exceeds the 50% threshold.

Referring back to FIG. 2, once the downstream road is identified, server 101 may determine the downstream TCIs and downstream DDI of downstream road 304 using road division unit 210, traffic congestion index unit 212, and directional imbalance unit 214 in the same manner as described above in detail with respect to road 102 and will not be repeated again. In some embodiments, road adjustment instruction unit 216 may be configured to provide the instruction to adjust first direction lane 104 and/or second direction lane 106 based on the DII of road 102 as well as the downstream DII of the downstream road (e.g., 304 in FIG. 3). For example, the instruction to adjust first direction lane 104 and/or second direction lane 106 of road 102 may be provided when the downstream DII of the downstream road (and/or the downstream TCIs) indicates that the downstream road is capable of absorbing the increased traffic volume upon the adjustment of road 102.

Memory 206 and storage 208 may include any appropriate type of mass storage provided to store any type of information that processor 204 may need to operate. Memory 206 and storage 208 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 206 and/or storage 208 may be configured to store one or more computer programs that may be executed by processor 204 to perform road condition analysis and adjustment functions disclosed herein. For example, memory 206 and/or storage 208 may be configured to store program(s) that may be executed by processor 204 to control sensors 110 and 112 to capture driving information and process the captured driving information to generate a road condition adjustment instruction.

Memory 206 and/or storage 208 may be further configured to store information and data used by processor 204. For instance, memory 206 and/or storage 208 may be configured to store the driving information captured by sensors 110 and 112 and preset parameters 209. The various types of data may be stored permanently, removed periodically, or disregarded immediately after each frame of data is processed.

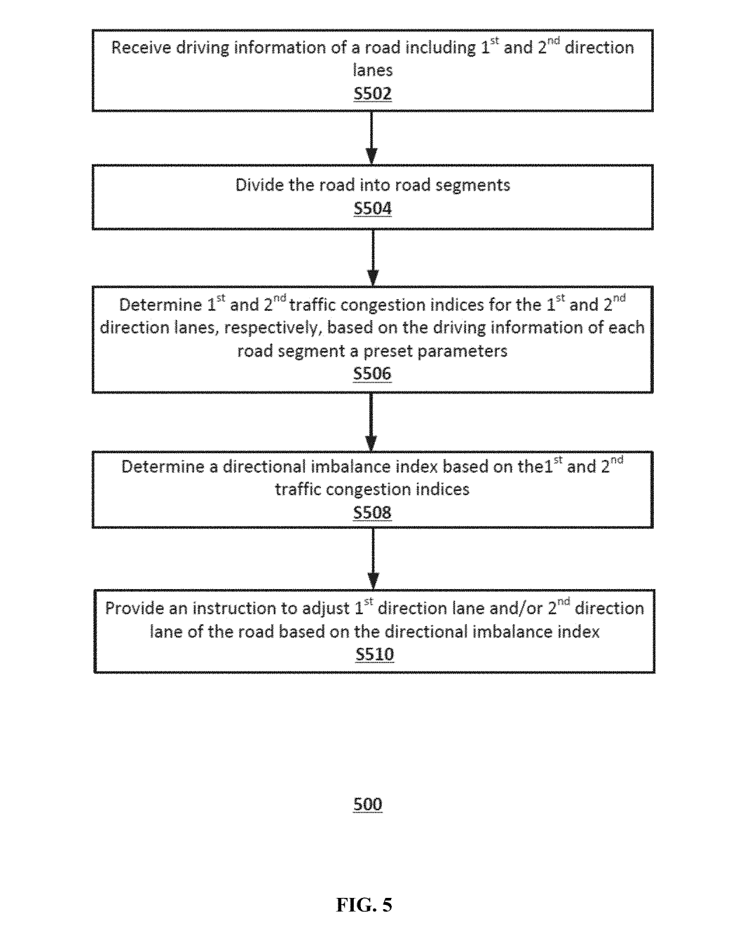

FIG. 5 illustrates a flowchart of an exemplary method 500 for adjusting road conditions, according to embodiments of the disclosure. For example, method 500 may be implemented by a road condition adjustment system 100 that includes, among other things, server 101 and sensors 110 and 112. However, method 500 is not limited to that exemplary embodiment. Method 500 may include steps S502-S510 as described below. It is to be appreciated that some of the steps may be optional to perform the disclosure provided herein. Further, some of the steps may be performed simultaneously, or in a different order than shown in FIG. 5.

In step S502, driving information of a two-way road is received. The road (e.g., road 102) may be a two-way road including first direction lane(s) and second direction lane(s). The driving information may be indicative of vehicle driving records on road 102 and include traffic volume, real-time driving speed, average driving speed, driving time, driving distance, etc. The driving information may be captured by sensors 110 equipped along road 102 and/or sensors 112 equipped on vehicles 114 driving through road 102 in a certain time period.

In step S504, the road is divided, by processor 204, into one or more road segments. In some embodiments, first direction lanes 104 and second direction lanes 106 may be each divided into road segments with the same distance based on, for example, the speed limit of road 102 and/or the environmental conditions of road 102. In some embodiments, at least some of the road segments may have different distances, for example, as divided based on the entrances and/or exits (e.g., highway ramps and traffic lights) of road 102. The driving information of road 102 may be associated with each road segment.

In step S506, a first traffic congestion index for the first direction lane and a second traffic congestion index for the second direction lane are determined respectively, by processor 204, based on the driving information associated with each road segment in the first direction lane and the second direction lane and a set of preset parameters. The preset parameters may include non-traffic passage time for each road segment in the first direction lane and the second direction lane, respectively. In some embodiments, the preset parameters may further include weights for each road segment in calculating the TCIs.

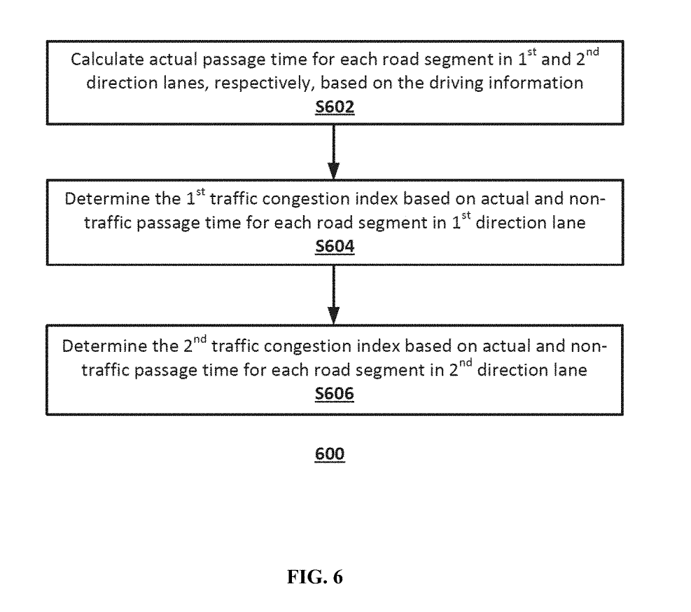

For example, FIG. 6 illustrates a flowchart of an exemplary method 600 for determining a traffic congestion index, according to embodiments of the disclosure. Method 600 may be one example of step S506. In step S602, actual passage time for each road segment in the first direction lane and the second direction lane, respectively, is determined based on the driving information. The actual passage time indicates the actual driving time of a vehicle passing through the respective road segment. In step 604, the first TCI is determined based on the actual passage time and non-traffic passage time for each road segment in the first direction lane. In some embodiments, the weights for each road segment in the first direction lane may be taken into account in determining the first TCI. In step 606, the second TCI is determined based on the actual passage time and non-traffic passage time for each road segment in the second direction lane. In some embodiments, the weights for each road segment in the second direction lane may be taken into account in determining the second TCI. For example, Equation (1) above shows an example of calculating the first TCI or second TCI.

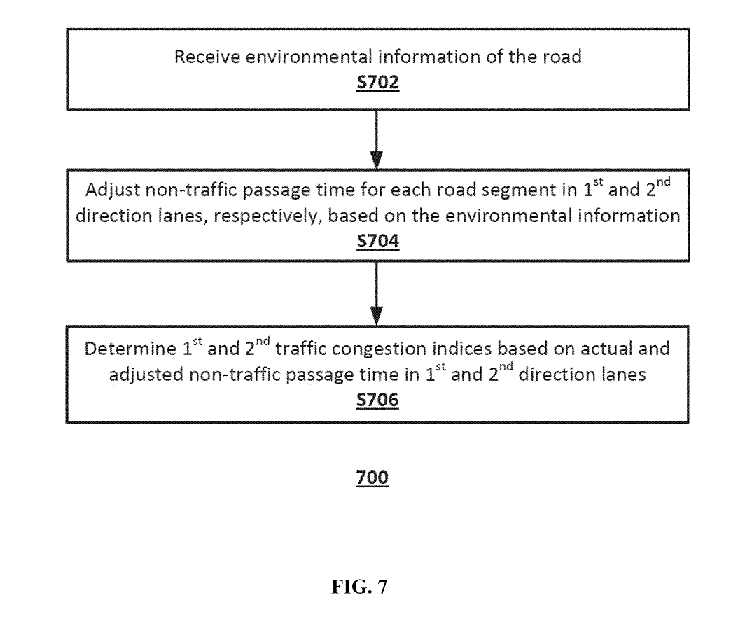

In some embodiments, environmental conditions of the road, such as air quality, precipitation, visibility, humidity, and wind speed, may be additionally considered for determining the TCIs. For example, FIG. 7 illustrates a flowchart of another exemplary method 700 for determining a traffic congestion index, according to embodiments of the disclosure. In step S702, environmental information indicative of environmental conditions of the road is received. In step S704, the non-traffic passage time for each road segment in the first and second direction lanes may be adjusted respectively based on the received environmental information. In some embodiments, the division of the road segments may take the environmental information into account as well. In step S706, the first and second TCIs are determined based on the actual passage time and the adjusted non-traffic passage time in the first and second direction lanes, respectively.

Referring back to FIG. 5, in step S508, a DII for the road is determined, by processor 204, based on the first and second TCIs. In some embodiments, the DII is determined only when one of the first and second TCI is above a threshold while another one of the first and second TCI is below the threshold. For example, Equation (2) above shows an example of calculating the DII. In step S510, an instruction to adjust the first direction lane and/or the second direction lane is provided, by processor 204, based on the DII. In some embodiments, the DII may be compared with a threshold before determining the instruction to be provided. In some embodiments, both the DII and the first and second TCIs may be used to determine the instruction to be provided. For example, when only one of the first and second TCIs is above the TCI threshold and the DII is above the threshold, the instruction directs traffic control and management mechanism 103 to reallocate the lanes in the first and second directions of road 102.

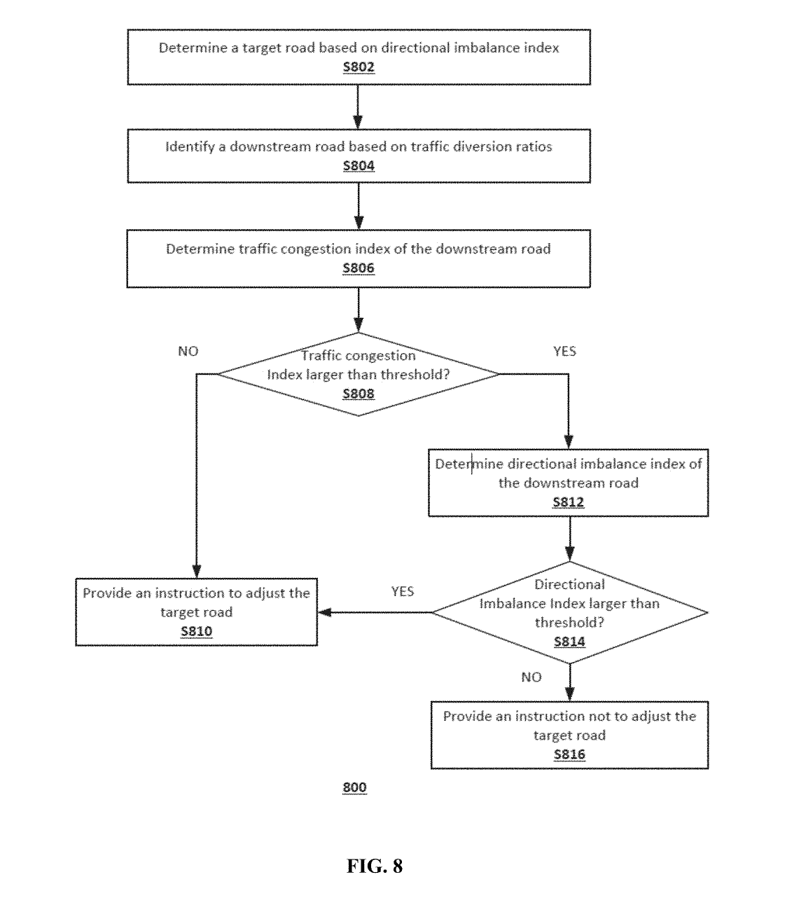

In some embodiments, traffic conditions of the downstream roads of the road (e.g., as represented by the TCIs and DII of a downstream road) may be used to provide the instruction to adjust the first direction lane and/or the second direction lane of the target road. For example, FIG. 8 illustrates a flowchart of an exemplary method 800 for adjusting road conditions based on downstream road conditions, according to embodiments of the disclosure. Method 800 may be implemented by road condition adjustment system 100. However, method 800 is not limited to that exemplary embodiment. Method 800 may include steps S802-S816 as described below. It is to be appreciated that some of the steps may be optional to perform the disclosure provided herein. Further, some of the steps may be performed simultaneously, or in a different order than shown in FIG. 8.

In step S802, a target road to be adjusted is determined based on the DII for the road. For example, the DII for the target road may be above the DII threshold while one of the TCIs for the target road is above the TCI threshold and the other one of the TCIs for the target road is below the TCI threshold. That is, only one direction of the target road has a significant traffic congestion, and the traffic of the target road in both directions is unbalanced, which leaves the room for adjustment.

In step S804, a downstream road is identified based on traffic diversion ratios of the downstream roads. The downstream direction may be determined based on the first and second TCIs of the target road, for example, the direction of the lanes having a significant traffic congestion. When there is more than one road adjacent to the target road in the downstream direction, one or more downstream roads may be identified based on their traffic diversion ratios. For example, any downstream roads with traffic diversion ratios above a threshold may be identified.

In step S806, the TCI for the downstream lane of the downstream road is determined. It is contemplated that the downstream road may be a two-way road having a first direction lane in the downstream direction (i.e., the downstream lane) and a second direction in the opposite direction of the downstream direction (i.e., the upstream lane). In this embodiment, only the TCI for the downstream lane, but not the TCI for the upstream lane, may be determined in step S806. In step S808, whether the TCI is larger than a threshold is determined. For example, the threshold may be 1.5. It is contemplated that the threshold may be any values larger than 1, for example, 1.1, 1.2, 1.3, 1.4, 1.5, etc.

If the TCI for the downstream lane of the downstream road is not larger than the threshold, i.e., the downstream lane has no significant traffic congestion, then in step S810, an instruction to adjust the target road is provided, for example, by server 101 to traffic control and management mechanism 103. Otherwise, method 800 proceeds to step S812 where the DII of the downstream road is determined. In determining the DII, the TCI for the upstream lane of the downstream road needs to be determined as well. The DII then may be calculated based on the TCIs for the downstream lane and upstream lane. In step S814, whether the DII is larger than a threshold is determined. For example, the threshold may be 80%. If the DII is larger than the threshold, i.e., the traffic of the downstream road is unbalanced in the both directions, then in step S810, an instruction to adjust the target road is provided, for example, by server 101 to traffic control and management mechanism 103. Otherwise, in step S816, an instruction not to adjust the target road is provided.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A system for adjusting road conditions, comprising:
a communication interface configured to receive driving information indicative of vehicle driving records on a road, wherein the road includes a first direction lane and a second direction lane;
a storage configured to store a set of preset parameters; and
a processor configured to:
divide the road into one or more road segments;
determine a first traffic congestion index and a second traffic congestion index for the first direction lane and the second direction lane, respectively, based on the driving information associated with each of the road segments and the set of preset parameters;
determine a directional imbalance index for the road based on the first traffic congestion index and the second traffic congestion index; and
provide an instruction to adjust at least one of the first direction lane and the second direction lane of the road based on the directional imbalance index.

2. The system of claim 1, wherein:
the communication interface is further configured to receive environmental information indicative of environmental conditions of the road; and
the processor is further configured to determine the first traffic congestion index and the second traffic congestion index for the first direction lane and the second direction lane, respectively, based on the driving information associated with each of the road segments, the environmental information, and the set of preset parameters.

3. The system of claim 1, wherein to provide the instruction, the processor is further configured to:
identify a downstream road of the road based on the first traffic congestion index and the second traffic congestion index;
determine a downstream directional imbalance index for the downstream road; and
provide the instruction to adjust the at least one of the first direction lane and the second direction lane of the road based on the directional imbalance index and the downstream directional imbalance index.

4. The system of claim 1, further comprising:
a sensor equipped along the road and/or a vehicle driving through the road and configured to capture the driving information.

5. The system of claim 1, wherein the set of preset parameters include non-traffic passage time for each of the road segments in the first direction lane and the second direction lane, respectively.

6. The system of claim 5, wherein to determine the first traffic congestion index and the second traffic congestion index, the processor is further configured to:
calculate actual passage time for each of the road segments in the first direction lane and the second direction lane, respectively, based on the driving information;
determine the first traffic congestion index based on the actual passage time and the non-traffic passage time for each of the road segments in the first direction lane; and
determine the second traffic congestion index based on the actual passage time and the non-traffic passage time for each of the road segments in the second direction lane.

7. The system of claim 3, wherein to identify the downstream road of the road, the processor is further configured to:
determine a downstream direction of the road based on the first traffic congestion index and the second traffic congestion index; and
select the downstream road, from one or more adjacent roads in the downstream direction of the road, based on traffic diversion ratios of each of the adjacent roads.

8. A method for adjusting road conditions, comprising:
receiving driving information indicative of vehicle driving records on a road, wherein the road includes a first direction lane and a second direction lane;
dividing, by a processor, the road into one or more road segments;
determining, by the processor, a first traffic congestion index and a second traffic congestion index for the first direction lane and the second direction lane, respectively, based on the driving information associated with each of the road segments and a set of preset parameters;
determining, by the processor, a directional imbalance index for the road based on the first traffic congestion index and the second traffic congestion index; and
providing, by the processor, an instruction to adjust at least one of the first direction lane and the second direction lane of the road based on the directional imbalance index.

9. The method of claim 8, further comprising:
receiving environmental information indicative of environmental conditions of the road; and
determining the first traffic congestion index and the second traffic congestion index for the first direction lane and the second direction lane, respectively, based on the driving information associated with each of the road segments, the environmental information, and the set of preset parameters.

10. The method of claim 8, wherein providing the instruction comprises:
identifying a downstream road of the road based on the first traffic congestion index and the second traffic congestion index;
determining a downstream directional imbalance index for the downstream road; and
providing the instruction to adjust the at least one of the first direction lane and the second direction lane of the road based on the directional imbalance index and the downstream directional imbalance index.

11. The method of claim 8, further comprising capturing the driving information by a sensor equipped along the road and/or a vehicle driving through the road.

12. The method of claim 8, wherein the set of preset parameters include non-traffic passage time for each of the road segments in the first direction lane and the second direction lane, respectively.

13. The method of claim 12, wherein determining the first traffic congestion index and the second traffic congestion index comprises:
calculating actual passage time for each of the road segments in the first direction lane and the second direction lane, respectively, based on the driving information;
determining the first traffic congestion index based on the actual passage time and the non-traffic passage time for each of the road segments in the first direction lane; and
determining the second traffic congestion index based on the actual passage time and the non-traffic passage time for each of the road segments in the second direction lane.

14. The method of claim 10, wherein identifying the downstream road of the road comprises:
determining a downstream direction of the road based on the first traffic congestion index and the second traffic congestion index; and
selecting the downstream road, from one or more adjacent roads in the downstream direction of the road, based on traffic diversion ratios of each of the adjacent roads.

15. A non-transitory computer-readable medium having instructions stored thereon that, when executed by one or more processors, causes the one or more processors to perform operations comprising:
receiving driving information indicative of vehicle driving records on a road, wherein the road includes a first direction lane and a second direction lane;
dividing the road into one or more road segments;
determining a first traffic congestion index and a second traffic congestion index for the first direction lane and the second direction lane, respectively, based on the driving information associated with each of the road segments and a set of preset parameters;
determining a directional imbalance index for the road based on the first traffic congestion index and the second traffic congestion index; and
providing an instruction to adjust at least one of the first direction lane and the second direction lane of the road based on the directional imbalance index.

16. The computer-readable medium of claim 15, wherein the operations further comprise:
receiving environmental information indicative of environmental conditions of the road; and
determining the first traffic congestion index and the second traffic congestion index for the first direction lane and the second direction lane, respectively, based on the driving information associated with each of the road segments, the environmental information, and the set of preset parameters.

17. The computer-readable medium of claim 15, wherein providing the instruction comprises:
identifying a downstream road of the road based on the first traffic congestion index and the second traffic congestion index;
determining a downstream directional imbalance index for the downstream road; and
providing the instruction to adjust the at least one of the first direction lane and the second direction lane of the road based on the directional imbalance index and the downstream directional imbalance index.

18. The computer-readable medium of claim 15, wherein the set of preset parameters include non-traffic passage time for each of the road segments in the first direction lane and the second direction lane, respectively.

19. The computer-readable medium of claim 18, wherein determining the first traffic congestion index and the second traffic congestion index comprises:
calculating actual passage time for each of the road segments in the first direction lane and the second direction lane, respectively, based on the driving information;
determining the first traffic congestion index based on the actual passage time and the non-traffic passage time for each of the road segments in the first direction lane; and
determining the second traffic congestion index based on the actual passage time and the non-traffic passage time for each of the road segments in the second direction lane.

20. The computer-readable medium of claim 17, wherein identifying the downstream road of the road comprises:
determining a downstream direction of the road based on the first traffic congestion index and the second traffic congestion index; and
selecting the downstream road, from one or more adjacent roads in the downstream direction of the road, based on traffic diversion ratios of each of the adjacent roads.
